(19) United States
(12) Patent Application Publication
(10) Pub. No.: US 2026/0001070 A1
(43) Pub. Date: Jan. 1, 2026

(54) BUBBLE DEFLECTION WITHIN A MICROFLUIDIC CHANNEL

(71) Applicant: Dynamic Biosensors GmbH, München (DE)

(72) Inventors: Nena MATSCHEKO, München (DE); Agnes MARSZAL, Kaufungen (DE); Andreas KRATZERT, München (DE); Tommi IJÄS, München (DE); Daliborka JAMBREC, München (DE); Ulrich RANT, München (DE)

(21) Appl. No.: 19/249,626

(22) Filed: Jun. 25, 2025

(30) Foreign Application Priority Data
Jun. 26, 2024 (EP) 24184831.6

(51) Int. Cl. B01L 3/00

(52) U.S. Cl. CPC B01L 3/502707; B01L 2200/027; B01L 2300/10

(57) ABSTRACT

A microfluidic device for bioassays, including: a microfluidic channel for guiding a process liquid in a direction of fluid flow from a fluid inlet of the microfluidic channel to a fluid outlet of the microfluidic channel via at least one region of interest for bioassays within the microfluidic channel; and a bubble deflection structure arranged in the microfluidic channel and adapted to deflect gas bubbles entering the microfluidic channel via the fluid inlet, such that the gas bubbles are guided through the microfluidic channel along at least one bubble path formed outside the region of interest, while allowing process liquid entering the microfluidic channel via the fluid inlet to flow through the region of interest.

### CROSS-REFERENCE TO RELATED APPLICATION(S)

This application claims priority to EP Application Serial No. 24184831.6, filed Jun. 26, 2024, which is hereby incorporated by reference in its entirety.

### DESCRIPTION

The present invention relates to devices and methods for improved bioassays (biological assay) through reduction of interference caused by foreign objects, such as bubbles, in a microfluidic channel.

Specifically in bioassays, the appearance of foreign objects, such as gas bubbles, in a liquid environment of a microfluidic system is a generally known and often undesirable issue. Foreign objects, such as gas bubbles can have detrimental effects when getting in contact with certain components at specific time points. For example, gas bubbles interfere with laminar flow at even pressure and velocity, decrease fluidic response time to flow rate changes due to dilation/expansion, they can damage cell membranes, block channels, displace analyte particles, or concentrate analyte particles at the gas/liquid interface.

Thus, while foreign objects (such as air bubbles or other gas bubbles, for example) can be detrimental for a biologic process (e.g. bioassays) in a microfluidic system, the micrometric dimensions of such systems can make it challenging to remove such foreign objects. Therefore, it is often desired, even though challenging, to avoid such foreign objects, including gas bubbles, from the beginning, or at least to remove them before they enter a microfluidic system. Solid objects are often removed by means of filter systems, such as membrane filters, that are inserted at an upstream side end of a microfluidic system, i.e. such that the foreign objects are removed from a liquid to be filled into the microfluidic system before that liquid enters a microfluidic channel and/or a region of interest (ROI) in such a microfluidic channel system.

The appearance of gas bubbles can have many different reasons and it is often desirable to understand the origin of such gas bubbles, since it can often be more efficient to even avoid appearance of gas bubbles than subsequently removing them. One of the initial challenges when initiating a microfluidic process is apparently the complete filling of the system with liquid, i.e. the complete removal of all undesired gas. A smart design of the microfluidic channel system, such as avoiding acute angles in a microfluidic channel, can help to support this initial startup. But even during a running process other effects, such as material porosity of setup components, setup leakage and/or gas dissolved in the process liquid can cause reoccurrence of gas bubbles. Various measures, even in combination with each other, such as process vessel fittings using Teflon seals, degassing the process fluid and/or the (porous) material of the channel setup and/or possibly even treating the internal surfaces of a microfluidic channel with soft surfactant prior to filling the system with the process fluid, can help initially avoiding or subsequently removing gas bubbles. Even temporarily applying a pressure pulse can support the removal of gas bubbles by forcing the gas bubbles to dissolve in the process liquid. Yet another approach is the integration of bubble traps in the microfluidic system. Such bubble traps may make use of hydrophobic membranes that expel gas bubbles from the process liquid, while preventing leakages of aqueous process liquid. One or more of these measures may be combined depending on the specific process and setup requirements.

It will become apparent that in specific cases not all of these measures are equally suitable. For example, while it appears advantageous to avoid the introduction of gas bubbles in a microfluidic system on the one hand, gas bubbles turned out to form a very efficient separator for different liquids in processes that require a switching between such different liquids, on the other hand. In cases, where a process switches the flow of liquid in a microfluidic system from a first type of liquid to a second type of liquid, the liquids often mix (e.g. by convection and/or diffusion) in a phase of transition from the first to the second liquid. The longer that channel path and the more complex the geometric design of that channel structure, the more intermixing of the two liquids occurs in the transitional phase. This typically results in an intrinsic latency in switching process conditions at specific points of interest in a microfluidic channel system.

Gas bubbles (such as air bubbles) can function as efficient separators between two liquids, which allow a rather instantaneous switching between different process conditions (related to the different process liquids) at a specific point of interest in a microfluidic system. In particular, when a process is to be switched from flowing a first type of process liquid in a first process phase to a second type of process liquid in a second process phase, a gas bubble intentionally introduced at the end of a first phase of the process and followed by the second process liquid can support to avoid mixing of the first and second process liquid. Since the gas is less likely to mix with the process liquids, depending on the channel structure and the surface tension of the process liquids at the boundary to the gas bubble, said gas bubble can act as a rather stable separator between the two types of liquid on its way through the microfluidic channel structure. This example shows that not all known techniques for bubble prevention or removal are applicable in all cases.

Accordingly, a particular technical problem underlying the present invention is the prevention of undesired impact of foreign objects to a specific region of interest in a microfluidic channel system, particularly for use in bioassays.

This problem is solved by the invention as defined in the independent claims. Preferred embodiments are defined in the dependent claims.

Accordingly, in one aspect a microfluidic device (particularly adapted for bioassays) is suggested, which comprises a microfluidic channel for guiding a process liquid in a direction of fluid flow from a fluid inlet of the microfluidic channel (at an upstream side of the microfluidic channel) to a fluid outlet of the microfluidic channel (at a downstream side of the microfluidic channel) via at least one region of interest adapted for bioassays within the microfluidic channel. The region of interest may be considered as a volume inside the microfluidic channel, which is spaced from at least one side wall of the microfluidic channel by a bubble deflection path and which is intended and adapted for performing bioassays in the environment provided by the process fluid. While the microfluidic channel may have a dedicated fluid inlet and a dedicated fluid outlet, thereby a dedicated direction of fluid flow, it may also be possible that the fluid inlet and fluid outlet change their function depending on a (switchable) mode of operation. Thus, the microfluidic channel may be a bidirectional channel that allows switching the direction of fluid flow.

According to the invention, the microfluidic device further comprises a bubble deflection structure (bubble deflector) arranged in the microfluidic channel and adapted to deflect gas bubbles entering the microfluidic channel via the fluid inlet, such that said gas bubbles are guided through the microfluidic channel along at least one bubble path formed outside the region of interest, while allowing process liquid entering the microfluidic channel via the fluid inlet to flow through the region of interest.

In other words, the bubble deflection structure is rather permeable for process liquid but impermeable for gas bubbles, at least when the gas bubbles arrive at the bubble deflector from the fluid inlet side of the microfluidic channel. Thus, while the process liquid penetrates the bubble deflection structure and at least partially flows through the region of interest, gas bubbles entering the microfluidic channel are deflected inside the microfluidic channel such that they are guided around the region of interest along the bubble path to pass the microfluidic channel without interfering with the region of interest. The bubble deflection structure forms a guard fence for the region of interest. Thereby, gas is prevented from reaching the region of interest and from displacing process liquid from the region of interest. This ensures that gas sensitive substance located and/or immobilized at the region of interest is protected from drying-out and/or from otherwise being adversely affected by direct contact with gas. With the bubble deflection structure forming a liquid permeable guard fence rather than a solid impermeable wall, the bubble deflection structure has no or only minimal direct impact on the flow characteristics of the process liquid. Specifically, flow of the process liquid can be maintained (largely) laminar over a large range of relevant flow rates, at least in the absence of gas bubbles.

Thus, the present invention provides a solution for excluding large objects, which may be air bubbles, from contact with a certain defined region within a fluidic channel, without blocking the continuous flow and circumventing the need to completely remove all air from the system. A significant difference to existing degasser/venting and bubble trap strategies is that the present invention is not generally removing air from liquid, but prevents its contact with certain regions of interest (ROI). Instead of removing air, it is guiding it. This is favorable if the air should be kept in the system, for example for purposeful liquid separation. Therefore, the present invention is superior to many conventional solutions that try to prevent gas/air in a microfluidic system.

The region of interest is preferable adapted to host and/or immobilize microscopic and/or nanoscopic substance and/or objects to be treated and/or examined. Examples of substances and/or objects of interest include molecules and/or molecule layers and/or bacteria and/or cells. The substances and/or objects of interest may be immobilized at the region of interest by various means including an object trap like a (partially open) cage and/or an adhesive surface coating at the region of interest, for example.

At the position of the region of interest, the bubble deflection structure divides the cross section of the microfluidic channel into at least two distinct sub-sections including a protected section and a bypass section, respectively. While the protected section includes the region of interest, the bypass section serves as the bubble path to guide gas bubbles through the microfluidic channel outside the region of interest.

In order to achieve that semi-permeable function with a permeability for the process liquid(s) and the deflection property for gas bubbles, the bubble deflection structure may include a plurality of liquid inlet windows for allowing process liquid arriving from the fluid inlet of the microfluidic channel to reach the region of interest, wherein a cross section of the liquid inlet windows is smaller than a cross section of the at least one bubble paths. Thereby, it is easier for the bubbles to pass the microfluidic channel through the bubble path outside the region of interest than entering the region of interest through the liquid inlet windows. In particular, the cross section of each liquid inlet window transverse to the direction of fluid flow is less than 20%, preferably less than 10%, more preferably less than 5%, even more preferably less than 2%, most preferably less than 1% of the cross section of the bubble path (bypass) as a position next to the region of interest transverse to the direction of fluid flow.

In a particularly preferred embodiment, the liquid inlet windows may have a cross section that allow passing of analyte particles (e.g. molecules, viruses, bacteria, cells) with a diameter not larger than a predetermined particle passage diameter, which is in the range of at least about 10 nm, preferably at least about 100 nm, more preferably at least about 1 μm. This means that particles having a diameter corresponding to the predetermined particle passage diameter of the liquid inlet windows or smaller can pass through the liquid inlet windows, while larger particles may be blocked/deflected. Thus, the particle passage diameter is a characteristic of the size (and/or shape) of the liquid inlet windows, which defines the maximum diameter of particles that can pass the liquid inlet windows. The specific size of the liquid inlet windows may be selected depending on the desired analytes to be used in the region of interest. For example, for molecular analytes the liquid inlet windows may allow passing of particles with a diameter of up to about 10 nm or about 20 nm or about 50 nm. For bacteria as analytes the liquid inlet windows may allow passing of particles with a diameter of up to about 100 nm or about 200 nm or about 500 nm. For cells as analytes the liquid inlet windows may allow passing of particles with a diameter of up to about 1 μm or about 2 μm or about 5 μm.

Preferably the inlet windows are small enough for the bubble deflection structure to prevent objects having a diameter of about 100 μm or more, preferably about 50 μm or more, more preferably about 20 μm or more, even more preferably about 10 μm, specifically preferably about 1 μm or more from entering the liquid inlet windows. This can efficiently prevent relevant gas bubbles from reaching the region of interest. Also in this respect, the specific size of the liquid inlet windows may be selected depending on the desired analytes to be used in the region of interest. For example in case of molecules as analytes, the size of the liquid inlet windows may be selected smaller, thereby preventing even smaller gas bubbles from reaching the region of interest than in case of cells as analytes.

In a preferred embodiment, the microfluidic channel has a cross section transvers to the direction of the (main) fluid flow specifically at the location of the at least one region of interest such that it supports a volumetric flow rate of the fluid flow of at least about 20 μl/min, more specifically at least about 40 μl/min and preferably in the range from about 40 μl/min to about 3.5 ml/min, more preferably in the range from about 100 μl/min to about 2 ml/min, particularly while applying a fluid velocity according to one of the following preferred values. In particular, in that case the fluid velocity of the fluid flow at the location of the region of interest may be a value of at least about 1 mm/s, preferably at least about 5 mm/s, more preferably at least about 10 mm/s, even more preferably at least about 50 mm/s, most preferably at least about 0.1 m/s or even at least about 0.5 m/s. Preferably, the fluid velocity at a location of the region of interest is specifically set to a value in the range of about 0.07 to about 0.74 m/s. Specifically, the microfluidic channel preferably has a cross section transvers to the direction of the fluid flow in the range of about 0.2·10⁴ μm² to about 20·10⁴ μm², more specifically in the range of about 1·10⁴ μm² to about 5·10⁴ μm².

In this context, the term “volumetric flow rate” is defined as the volume of fluid which passes through the microfluidic channel in which the region of interest is arranged per unit time. Further, the term “fluid velocity” (or “flow velocity”) is defined as the momentary velocity of an element of fluid at a given location.

Preferably, the bubble deflection structure may include at least one gas escape opening towards the fluid outlet, i.e. towards the downstream direction of the microfluidic channel. In particular, the gas escape opening(s) may be larger than the liquid inlet windows. For example, the cross section of the gas escape opening may be at least about 25%, preferably at least about 50%, more preferably at least about 75% of the maximum cross section of the bubble deflection structure transverse to the direction of fluid flow. The gas escape opening supports the removal of gas from the region of interest when initially flooding the microfluidic device before starting analytics. Thus, the asymmetric structure of the bubble deflection structure with regards to the upstream and downstream directions supports removal of gas from the region of interest (e.g. when setting up the system at the beginning) while preventing entry of gas to the region of interest during operation of the microfluidic device.

In a preferred embodiment, the bubble deflection structure has a pointed shape towards the fluid inlet of the microfluidic channel, i.e. towards the upstream direction. The pointed shape of the bubble deflection structure may enhance splitting on incoming (large) bubbles into smaller bubbles. This may enhance a smooth deflection of the gas bubbles and passing them along one side of the region of interest but outside thereof. The bubble deflection structure may narrow the effective channel width for the gas bubbles to pass. With larger bubbles being split into smaller ones, the risk of temporary blocking of the bubble path by large gas bubbles and/or the pressure drop along the bubble path may be reduced. This can improve a continuous (preferably laminar) flow of process liquid even in/through the regions of interest.

Preferably the bubble deflection structure may encompass, alone or in (structural and functional) cooperation with one or more walls of the microfluidic channel, a convex space that fully contains the at least one region of interest. In other words, it is preferred that the bubble deflection structure extends from a position upstream relative to the region of interest to a position downstream relative to the region of interest. In this respect, the bubble deflection structure may (continuously) deflect and guide gas bubbles from a position more upstream (i.e. closer to the fluid inlet) than the region of interest to a position more downstream (i.e. closer to the fluid outlet) than the region of interest.

Accordingly, the bubble deflection structure preferably does not only protect the region of interest from bubbles arriving from the upstream side directly, but also avoids that bubbles guided in the bypass along a side of the region of interest interfere with a substance located and/or a process performed at the region of interest, until the gas bubble has completely passed the region of interest, i.e. until the gas bubble leaves the bypass at a position more downstream than the region of interest. Once the bubbles have passed the bubble deflection structure, the bubbles may expand and/or move over the whole cross section of the microfluidic channel.

Preferably the bubble path (bypass) is formed between the bubble deflection structure and at least one wall of the microfluidic channel. Alternatively or additionally, the microfluidic device may have a first bubble deflection structure and a second bubble deflection structure, each protecting at least one region of interest, wherein the bubble path is formed between the first and the second bubble deflection structure.

In a preferred implementation, the bubble deflection structure may comprise a plurality of substantially parallel pillars, which are each attached with their opposite ends to opposing inner surfaces of the microfluidic channel. Preferably, these pillars form a fence-like structure, that protects the region of interest from gas bubbles interfering therewith. The pillars may be formed separately or may be connected to each other via linking elements to form a meshwork. The plurality of pillars may have substantially constant and/or identical diameter. Alternatively, the diameter of each pillar may change over its length, e.g. with a larger diameter/cross section close to connection points with a respective wall of the microfluidic channel. Alternatively or additionally, the bubble deflection structure may comprise a plurality of mounds/pyramids and/or hourglass-shaped elements. In yet another implementation, the bubble deflection structure may comprise a continuous wall with openings to form liquid inlet windows.

In one implementation, the bubble deflection structure is attached with one end (section) thereof (e.g. the lower end) to an inner surface of a first fluid channel wall, such as a bottom wall (base wall), and with another end (section) thereof (e.g. an upper end) to an inner surface of a second fluid channel wall, such as a top wall (cover) of the microfluidic channel substantially opposite to the first fluid channel wall. Thereby, each of opposite end sections of the bubble deflection structure can be stably held at opposite walls of the microfluidic channel, thereby ensuring a high stability of the whole bubble deflection structure even under fluid flow conditions with high flow velocities.

Preferably, the bubble deflection structure may be compressed between inner surfaces of the first and second microfluidic channel wall. Specifically, the bubble deflection structure can be initially manufactured with a height that is larger than the height of the microfluidic channel (i.e. the distance between first and second microfluidic channel walls) before said opposing microfluidic channel walls are assembled, so that the bubble deflection structure is clamped between these channel walls (e.g. the bottom and top surfaces of said channel. Specifically, the height of the bubble deflection structure may initially be 10% to 30% larger than the height of the microfluidic channel.

Preferably, the microfluidic channel has a substantially rectangular cross section transverse to the (main) fluid flow direction. In that respect, preferred values for a height of the microfluidic channel range from about 20 μm to about 100 μm, preferably about 30 μm to about 75 μm. Moreover, preferred values for a width of the microfluidic channel range from about 200 μm to about 1000 μm.

The bubble deflection structure to be used in the present invention can be fabricated by photolithography or etching for placing micrometer sized structures onto a microfluidic channel. To allow for refined shapes in the nanometer to micrometer scale, a two-photon polymerization (2PP) technique can be employed to generate fences within the microfluidic system that allow the unobstructed passing of liquid, but retain and guide larger objects such as gas/air bubbles to pass by the protected region of interest (ROI). Specifically, photon-stimulated polymerization, such as 2-photon polymerization (2PP) may be employed as known in the art. Accordingly, the material of said structures may be made of or may include suitable photopolymers, such as negative tone IP-Dip or IP-Visio photoresins, SU8, positive tone photopolymers and/or hydrogels.

The bottom surface of the microfluidic channel used in connection with the present invention, i.e., the surface on which the bubble deflection structure may be adhered, is not particularly limited and may include any surface on which respective structures can be fabricated by 2PP. Suitable materials in this respect include glass, silicon, metals (e.g. gold and/or chrome), ceramics and/or polymers such as polydimethylsiloxane (PDMS), polypropylene (PP) and/or SU8. In preferred embodiments, the bottom surface of the microfluidic channel, and/or the top surface of said channel, are made of an optically transparent material, e.g. glass, in order to allow for microscopic, e.g. fluorescence microscopic, observation and/or analysis of substance/objects of interest within the region of interest.

In one aspect, the invention further relates to a use of a microfluidic device according to the invention, in particular when implemented in one of the preferred embodiments described herein, for a bioassay, wherein process liquid is passed through the microfluidic channel from the fluid inlet to the fluid outlet. A (biologic) substance/object may be located/immobilized at the region of interest for analysis preferably under fluid flow conditions. The bubble deflection structure thereby protects the substance/object of interest from undesired interference with gas bubbles entering the microfluidic device-either intentionally or unintentionally.

Specifically for the purpose of bioassays, but not limited thereto, the invention further provides a method of operating a microfluidic device according to the invention, in particular when implemented in one of the preferred embodiments described herein. This operation method passes process liquid through the microfluidic channel from the fluid inlet to the fluid outlet. At least under these operation conditions, the bubble deflection structure can efficiently protect the region of interest from undesired interference with gas bubbles entering the microfluidic device-either intentionally or unintentionally.

Specifically for analyzing a substance or object of interest under fluid flow conditions, the operation method may comprise immobilizing said substance or object of interest at the region of interest. In a preferred embodiment, the method may comprise flooding the microfluidic channel (including the regions of interest) of the microfluidic device with a first process liquid; and inserting gas (i.e. a gas bubble) followed by a second process liquid into the microfluidic channel via the fluid inlet of the microfluidic channel, thereby replacing the first process liquid in the microfluidic channel by the second process fluid. Specifically, the gas (bubble) may separate the second process fluid from the first process fluid in the microfluidic channel in the parts other than the bubble deflection structure. In this case it is desirable to insert a gas bubble that is large enough to be able to fill the whole cross section of the microfluidic channel in its sections away from the bubble deflection structure. This can ensure an efficient separation of the first and second process fluid in order to avoid or reduce mixing of the process fluids in parts of the microfluidic device other than the bubble deflection structure, specifically at least in those parts upstream relative to the bubble deflection structure.

Further details and advantages for preferred embodiments of the present invention will be described with reference to the attached figures, which show:

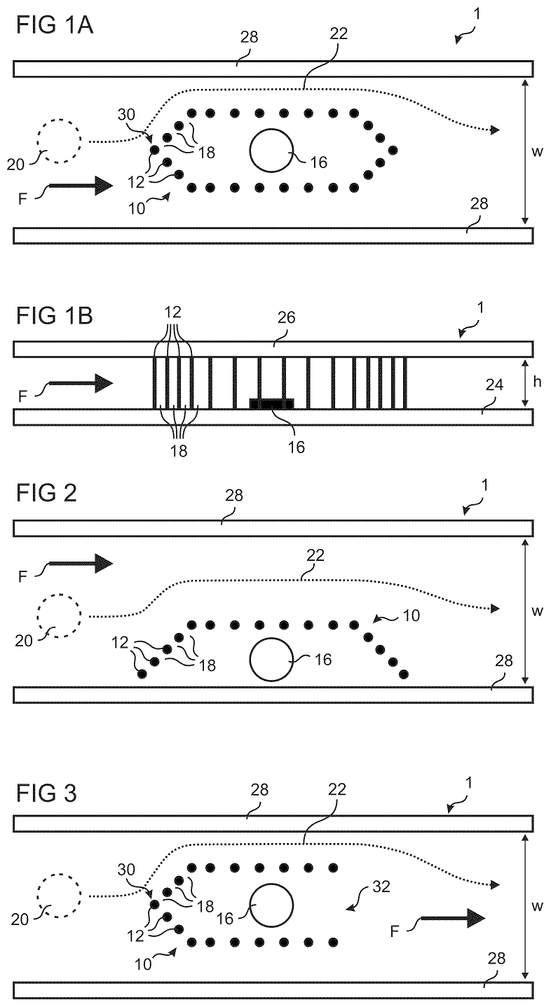

FIG. 1A a schematic top view of a microfluidic device with a bubble deflection structure according to a preferred embodiment of the present invention;

FIG. 1B a schematic side view of the microfluidic device of FIG. 1A;

FIG. 2 a schematic top view of a microfluidic device with a bubble deflection structure according to another preferred embodiment of the present invention;

FIG. 3 a schematic top view of a microfluidic device with a bubble deflection structure according to another preferred embodiment of the present invention;

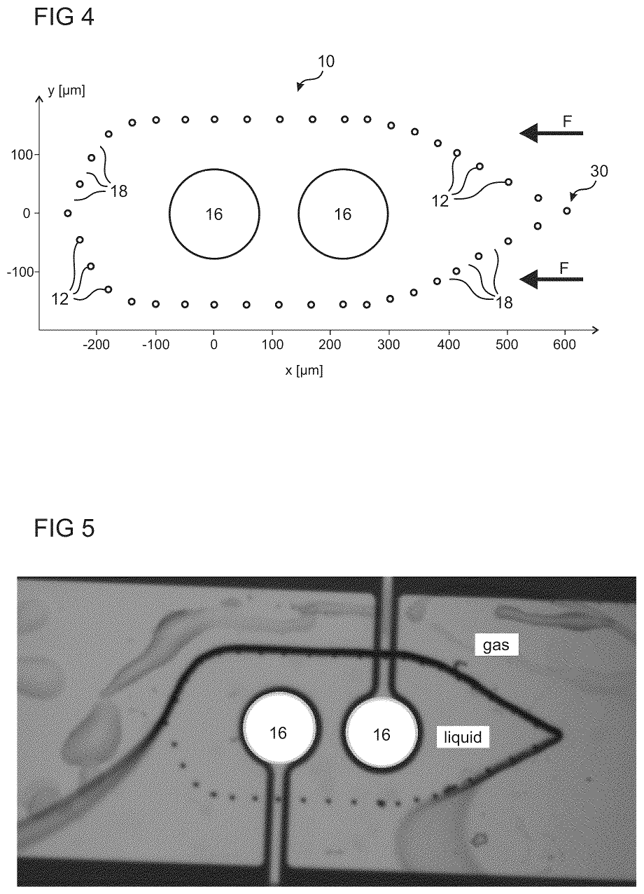

FIG. 4 an example of a possible arrangement of a bubble deflection structure in a top view drawn to scale in an exemplary implementation of the invention;

FIG. 5 a microscopic snapshot in a top view of a microfluidic device during gas injection for the transition from a first process liquid to a second process liquid; and

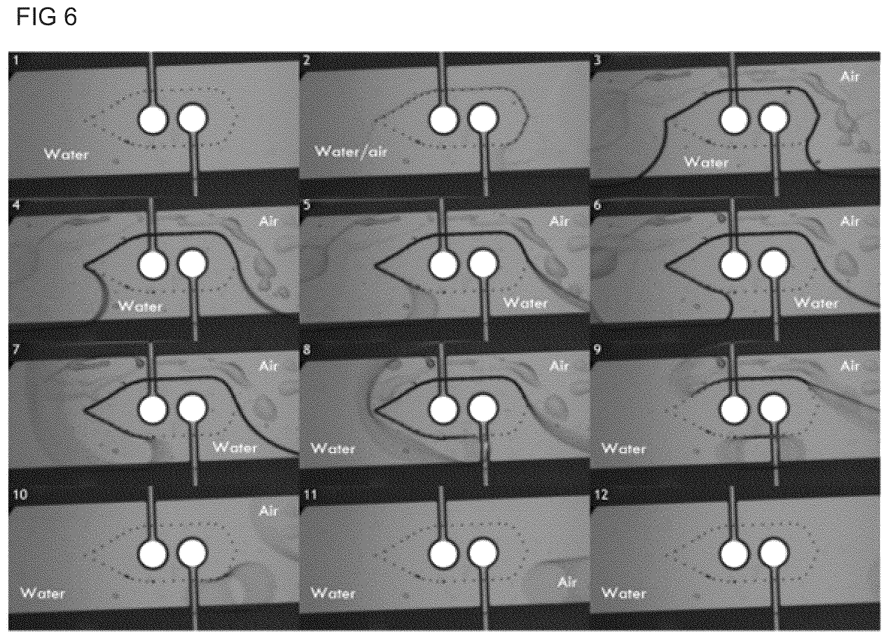

FIG. 6 a sequence of 12 microscopic snapshots in a top view of a microfluidic device during the transition from a first process liquid to a second process liquid separated from the first process liquid by an intentionally injected gas bubble.

Gas, such as air, (bubbles) can be used in a microfluidic system for efficient separation of different aqueous solutions or other process liquids, yielding sharp transitions from one process liquid to another. The present invention describes a solution for excluding large objects, which may be gas bubbles, from contact with a certain defined region within a fluidic channel, without blocking the continuous flow and circumventing the need to completely remove all gas/air from the system.

FIG. 1A represents a schematic top view of a microfluidic device 1 having a microfluidic channel with a bubble deflection structure 10 according to a preferred embodiment of the present invention. In this embodiment the microfluidic channel has a substantially rectangular cross section with a channel width w between two side walls 28. A region of interest 16 is arranged in the microfluidic channel, in this case widthwise substantially in the middle of the microfluidic channel. This region of interest 16 may be subject of analysis (such as spectroscopic analysis) of a substances/objects of interest immobilized at the region of interests during bioassays under flow conditions, for example. For that purpose, the microfluidic channel supports flow of a process liquid along a direction of fluid flow F within the microfluidic channel from a fluid inlet to a fluid outlet of the microfluidic channel.

As illustrated in FIG. 1A, in this preferred embodiment, the bubble deflection structure 10 is built from a plurality of pillars 12 that form a fence structure around the region of interest 16, while leaving bypasses between the bubble deflection structure 10 and each of the side walls 28 of the microfluidic channel. This fence structure formed by the pillars 12 of the bubble deflection structure 10 deflects gas bubbles 20 that enter the microfluidic channel via the fluid inlet, such that said gas bubbles 20 are guided through the microfluidic channel along at least one bubble path 22 formed as (bubble) bypass outside the region of interest 16. Windows/openings 18 formed in the bubble deflection structure between the pillars 12 allow the process liquid entering the microfluidic channel via the fluid inlet to flow into the fence structure and through the region of interest 16. In particular, while some of the windows 18 formed at the upstream side of the bubble deflection structure serve as liquid inlet windows allowing the process liquid to enter the region inside the fence structure, other windows 18 formed at the downstream side of the bubble deflection structure 10 serve as liquid outlet windows allowing the process liquid to leave the region of inside the fence structure (where the region of interest 16 is located).

In the preferred embodiment shown in FIG. 1A, the bubble deflection structure has a pointed shape 30 towards the fluid inlet of the microfluidic channel, i.e. towards the upstream direction (left side in FIG. 1A). This pointed shape 30 formed by the inlet-facing apex angle of the bubble deflection structure 10 may enhance splitting on incoming (large) bubbles into smaller bubbles. This may enhance a smooth deflection of the gas bubbles and passing them along one or both sides of the region of interest in the respective bypasses formed between the bubble deflection structure 10 and the side walls 28. Since these bypasses are narrower than the channel width w, the splitting of larger bubbles into smaller ones enhances the smooth deflection of the bubbles to guide them along the bubble path 22 and reduces the risk of temporary blocking of the bubble path by large gas bubbles. This can improve a continuous (preferably laminar) flow of process liquid even in/through the region of interest 16.

FIG. 1B shows a schematic side view of the microfluidic device of FIG. 1A. As can be seen from FIG. 1B, in this preferred embodiment the plurality of substantially parallel pillars are each attached with their opposite ends to opposing inner surfaces of the substantially rectangular microfluidic channel having a channel height h. In particular, the pillars 12 are attached with their one ends (the lower ends) to an inner surface of a bottom wall 24 (base wall), and with their respective other ends (the upper ends) to an inner surface of a top wall 26 (cover) of the microfluidic channel. Thereby, each of the opposite ends of the bubble deflection structure can be stably held at opposite walls of the microfluidic channel, thereby ensuring a high stability of the whole bubble deflection structure 10 even under fluid flow conditions with high flow velocities.

FIG. 2 shows a schematic top view of a microfluidic device 1 with a bubble deflection structure 10 according to another preferred embodiment of the present invention. In this exemplary embodiment, the region of interest 16 is positioned away from the center of the microfluidic channel in the widthwise direction. Likewise is the bubble deflection structure 10 positioned away from that center. In particular, in this embodiment the bubble deflection structure 10 is arranged at one sidewall 28 of the microfluidic channel. Moreover, the bubble deflection structure 10 structurally and functionally cooperates with said side wall 28 to deflect bubbles 20, to guide them along the bubble path 22 and to prevent them from interfering with the region of interest 16. Analogous to the embodiment in FIG. 1, the process liquid is allowed to enter the inside region of the bubble deflection structure 10 and thereby the region of interest 16. The embodiment of FIG. 2 does not provide a bubble splitting function.

FIG. 3 shows a schematic top view of a microfluidic device 1 with a bubble deflection structure 10 according to yet another preferred embodiment of the present invention. Regarding the placement of the region of interest as well as the bubble deflection structure, this embodiment is again rather similar to the one in FIG. 1. Therefore, for further details, reference is made to the description of FIG. 1A and FIG. 1B, above.

In this embodiment, however, the bubble deflection structure 10 includes a gas escape opening 32 towards the fluid outlet, i.e. towards the downstream direction of the microfluidic channel (right side in FIG. 3). The gas escape opening 32 supports the removal of gas from the region of interest 16 when initially flooding the microfluidic device 1 before starting analytics, while preventing entry of gas to the region of interest 16 during operation of the microfluidic device 1 with fluid flow along direction F.

In all embodiments shown in the figures, the bubble deflection structure 10 extends from a position upstream relative to the region of interest 16 to a position downstream relative to the region of interest 16. Thereby, the bubble deflection structure 10 deflects incoming gas bubbles 20 from directly reaching the region of interest 16 from the upstream side of the microfluidic channel. Additionally, with this preferred geometry, the bubble deflection structure 10 guides the gas bubbles 20 around the region of interest 16 at least until they have reached a position that is more downstream than the region of interest 16. This can reduce the risk that gas bubbles may interfere with the region of interest.

FIG. 4 shows an example of a possible arrangement of a bubble deflection structure in a top view drawn to scale in an exemplary implementation of the invention. In this embodiment, the bubble deflection structure encompasses two regions of interest. The fluid inlet side in the representation of FIG. 4 is facing to the right side. FIG. 5 is a microscopic snapshot in a top view of a microfluidic device corresponding to FIG. 4 during gas injection for the transition from a first process liquid to a second process liquid.

In a more detailed aspect, this specific embodiment features a pointed design towards the incoming fluid flow, and a more rounded design at the back towards the outlet. This design enhances the splitting of large air bubbles injected into the microfluidic channel and allows them to slide past the protected area in continuous buffer flow. The gaps (windows) between the pillars are large enough to allow unobstructed laminar flow inside the protective structure, i.e. at the regions of interest, and the entry of smaller objects below 30-50 μm. Higher pressure on air bubbles passing by between the structure and the channel side wall require a closer distance between the pillars to prevent the entry of air. Once past the region of interest, the air bubble can expand again to fill the entire channel and will be flushed out with continuous high-pressure buffer flow. The whole process of injecting a gas bubble to separate a first process liquid from a second process liquid is shown in the sequence of snapshots in FIG. 6, but with a general fluid flow direction from left to right. The snapshot “5” in the sequence of snapshots in FIG. 6 substantially corresponds to the situation in FIG. 5.

In summary, the present invention enables sharp transitions between different liquids in a microfluidic system by gas separation, without the detrimental effects of gas on specific ROIs. A multitude of technologies, including techniques for cell sorting, characterizing, and culturing, is using microfluidic systems with potential applications of this guiding invention.

### LIST OF REFERENCE NUMBERS

1 microfluidic device
10 bubble deflection structure
12 pillar
16 region of interest
18 window/opening
20 bubble
22 bubble path
24 bottom wall/base wall
26 top wall/cover
28 side wall
30 pointed structure/bubble splitter
32 gas escape opening
F fluid flow (direction)
h channel height
W channel width

1. A microfluidic device for bioassays, comprising:
a microfluidic channel for guiding a process liquid in a direction of fluid flow from a fluid inlet of the microfluidic channel to a fluid outlet of the microfluidic channel via the at least one region of interest for bioassays within the microfluidic channel;
a bubble deflection structure arranged in the microfluidic channel and adapted to deflect gas bubbles entering the microfluidic channel via the fluid inlet, such that said gas bubbles are guided through the microfluidic channel along at least one bubble path formed outside the region of interest, while allowing process liquid entering the microfluidic channel via the fluid inlet to flow through the region of interest.

2. The microfluidic device of claim 1 for bioassays at microscopic and/or nanoscopic substances and/or objects to be treated and/or examined, wherein the microfluidic channel comprises at least one region of interest adapted to host and/or immobilize said microscopic and/or nanoscopic substances and/or objects to be treated and/or examined.

3. The microfluidic device of claim 2, wherein the at least one region of interest is adapted to host and/or immobilize molecules and/or molecule layers and/or bacteria and/or cells.

4. The microfluidic device of claim 2, wherein the at least one region of interest is adapted to host and/or immobilize microscopic and/or nanoscopic substances and/or objects by means of an object trap and/or an adhesive surface coating.

5. The microfluidic device of claim 1, wherein the bubble deflection structure includes a plurality of liquid inlet windows for allowing process liquid arriving from the fluid inlet of the microfluidic channel to reach the region of interest, wherein a cross section of the liquid inlet windows is smaller than a cross section of the at least one bubble paths.

6. The microfluidic device of claim 5, wherein the liquid inlet windows have a cross section that allow passing of analyte particles with a diameter not larger than a predetermined particle passage diameter, which is in the range of at least about 10 nm.

7. The microfluidic device of claim 5, wherein the inlet windows are small enough for the bubble deflection structure to prevent objects having a diameter of about 100 μm or more from entering the liquid inlet windows (18).

8. The microfluidic device of claim 1, wherein the microfluidic channel has a cross section transverse to the direction of fluid flow in the range of about 0.2·10⁴ μm² to about 20·10⁴ μm².

9. The microfluidic device of claim 1, wherein the bubble deflection structure includes at least one gas escape opening towards the fluid outlet.

10. The microfluidic device of claim 1, wherein the bubble deflection structure has a pointed shape towards the fluid inlet.

11. The microfluidic device according to claim 1, wherein the bubble deflection structure encompasses a convex space that fully contains the at least one region of interest.

12. The microfluidic device of claim 1, wherein the bubble path is formed between the bubble deflection structure and at least one wall of the microfluidic channel.

13. The microfluidic device of claim 1, wherein the bubble deflection structure comprises a plurality of substantially parallel pillars, which are each attached to opposing inner surfaces of the microfluidic channel.

14. Use of a microfluidic device according to claim 1 for a bioassay.

15. Method of operating a microfluidic device of claim 1, comprising:
passing process liquid through the microfluidic channel from the fluid inlet to the fluid outlet.

16. Method of claim 15, comprising:
flooding the microfluidic channel of the microfluidic device with a first process liquid; and
inserting gas followed by a second process liquid into the microfluidic channel via the fluid inlet of the microfluidic channel, thereby replacing the first process liquid in the microfluidic channel by the second process fluid.
